(19) United States
(12) Patent Application Publication
(10) Pub. No.: US 2012/0125145 A1
(43) Pub. Date: May 24, 2012

(54) Pivotable Handlebar for Locking and Efficient Storage of a Bicycle

(76) Inventor: Claude VanderVeen, Cudahy, WI (US)

(21) Appl. No.: 12/949,101

(22) Filed: Nov. 18, 2010

(51) Int. Cl. B62K 21/18; B62K 21/16

(52) U.S. Cl. 74/551.8

(57) ABSTRACT

The present invention is a pivotable handlebar stem apparatus comprised of a clamp body, a cam lock, and a positioning component. The clamp body fits around a handlebar stem or portion of the handlebars of a bicycle. When the cam lock is unlocked and the positioning component is disengaged, the handlebars may be rotated from a riding position to a parked position for convenient storage, transport and parking.

### FIELD OF INVENTION

The present invention relates to the field of pivotable handlebar stems, and more specifically to a multi-purpose pivotable handlebar assembly that utilizes a clamping force.

### BRIEF DESCRIPTION OF THE DRAWINGS

FIG. 1a illustrates a perspective view of an exemplary embodiment of a pivotable handlebar stem apparatus with cam lock locked, positioning component engaged, and handlebars in the riding position.

FIG. 1b illustrates a perspective view of an exemplary embodiment of a pivotable handlebar stem apparatus with cam lock unlocked, positioning component disengaged, and handlebars in the riding position.

FIG. 1c illustrates a perspective view of an exemplary embodiment of a pivotable handlebar stem apparatus with cam lock locked, positioning component engaged, and handlebars in the parked position.

FIG. 2 illustrates an exploded view of an exemplary embodiment of a pivotable handlebar stem apparatus.

FIG. 3 illustrates a sectional view of an exemplary embodiment of a pivotable handlebar stem apparatus and handlebar assembly.

FIG. 4 illustrates a perspective view of an exemplary embodiment of a pivotable handlebar stem apparatus with an anti-theft lock assembly.

FIG. 5 illustrates a perspective view of an exemplary alternative embodiment of a pivotable handlebar stem apparatus which utilizes a straight line action clamp as a positioning component.

FIG. 6 illustrates a perspective view of a second exemplary embodiment of a pivotable handlebar stem apparatus with cam lock unlocked, positioning component disengaged, and handlebars in the riding position.

FIG. 7 illustrates a sectional view of a second exemplary embodiment of a pivotable handlebar stem apparatus with positioning component engaged and handlebars in the riding position.

FIG. 8 illustrates a perspective view of a third exemplary embodiment of a pivotable handlebar stem apparatus with an anti-theft lock assembly and with cam lock locked, positioning component engaged, and handlebars in the riding position.

FIG. 9 illustrates an exploded view of a third exemplary embodiment of a pivotable handlebar stem apparatus with an anti-theft lock assembly.

### GLOSSARY

As used herein, the term “clamping force” refers to pressure applied to a clamp body that secures the handlebars in position.

As used herein, the term “positioning component” refers to a component that may be engaged or disengaged in a hole or slot to prevent or allow positional rotation of the handlebars between riding and parked positions. A positioning component may be any structure known in the art that securely engages one or more movable parts in position, including but not limited to a pin, a lever, a spring release, a push button, a straight line action clamp, a stop, or any component known in the art which facilitates locking when engaged and positioning when disengaged.

As used herein, the term “rigidity” refers to a condition in which movement and/or repositioning of adjacent components is minimized or limited.

### BACKGROUND

Many municipalities and college campuses encourage the use of bicycles. Barriers to bicycle use include lack of storage space when the bike is not in use and risk of theft.

The handlebars of conventional bicycles are much wider than the bicycle frame and allow only for minimal rotation, increasing the amount of space required to store a bicycle and making it problematic to store a bicycle in smaller areas, such as a hallway, dorm room, or a garage with limited storage space. The width of the handlebars also makes transporting a bicycle on a vehicle with a bicycle rack, in a vehicle without a bicycle rack, or on a boat or kayak more difficult. In addition, in crowded bicycle racks, the width of the handlebars also makes it difficult to squeeze in and remove a bicycle from between other bicycles.

There have been a few attempts in the prior art to create a pivotable handlebar stem which allows the handlebars to be pivoted for more convenient storage. One example of a pivotable handlebar stem is disclosed by U.S. Pat. No. 5,727,427 (Nien '427). Nien '427 discloses a pivotable handlebar stem comprised of a column with an extension tube extending from the column. The extension tube has a piston and a clamp with an undulating face formed on the free ends of both the extension tube and the clamp. When the free ends of the extension tube and clamp are mated, the extension tube and clamp are securely connected together. A coil spring is located between a rib of the extension tube and the second end of the piston. When the bicycle is parked, the rider pushes a positioning button downward to release connection between the extension tube and the piston. The clamp and handlebar are then pulled out and the handlebar is turned to an angle which is perpendicular to the horizontal riding position. The coil spring then causes the clamp to recoil back to connect with the extension tube.

The pivotable handlebar stem taught by Nien '427 is undesirable for a number of reasons. The handlebar stem taught by Nien 427 uses interlocking components that offer minimal control when adjusting the position of the handlebars. The handlebar stem relies on a coil spring to reengage the interlocking piston and the extension tub; a coil spring does not provide the rigidity required for bicycle safety by allowing play in the handlebars when the bike is in use. The pivotable handlebar stem taught by Nien'427 also requires specially machined parts, which must be installed during the manufacturing of the bicycle.

Theft of bicycles is also a concern, especially on college campuses. According to FBI statistics, 1.5 million bicycles are stolen every year.

It is desirable to have a pivotable handlebar stem apparatus with a rigidity comparable to the handlebar stems of conventional bicycles.

It is desirable to have a pivotable handlebar stem apparatus which allows handlebars to be positioned only in a riding position and a parked position ensuring that the handlebars are always correctly positioned.

It is desirable to have a pivotable handlebar stem apparatus which further includes an anti-theft lock assembly which prevents the handlebars from being rotated from a parked position to a riding position, serving as a theft deterrence.

It is desirable to have a pivotable handlebar stem apparatus which requires a minimal number of specially manufactured components.

It is further desirable to have a pivotable handlebar stem apparatus which can be installed during the manufacturing of the bicycle or being purchased and installed aftermarket.

### SUMMARY OF THE INVENTION

The present invention is a pivotable handlebar stem apparatus comprised of a clamp body, a cam lock, and a positioning component. The clamp body fits around a handlebar stem or portion of the handlebars of a bicycle. When the cam lock is unlocked and the positioning component is disengaged, the handlebars may be rotated from a riding position to a parked position for convenient storage. The pivotable handlebar stem apparatus may further include an anti-theft lock assembly, which prevents the handlebars from being rotated without first unlocking a separate locking mechanism (e.g., using a key).

### DETAILED DESCRIPTION OF INVENTION

For the purpose of promoting an understanding of the present invention, references are made in the text to exemplary embodiments of a pivotable handlebar stem apparatus for efficient storage of a bicycle, only some of which are described herein. It should be understood that no limitations on the scope of the invention are intended by describing these exemplary embodiments. One of ordinary skill in the art will readily appreciate that alternate but functionally equivalent components, materials, placement, and designs may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings are not necessarily to scale; instead, emphasis has been placed upon illustrating the principles of the invention. In addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change in the basic function to which it is related.

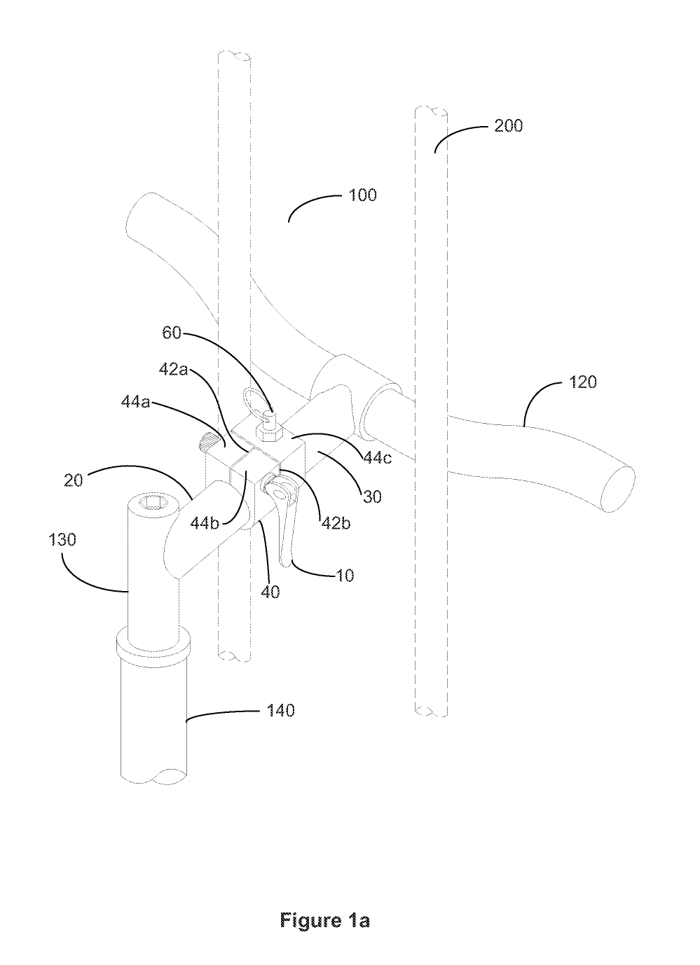

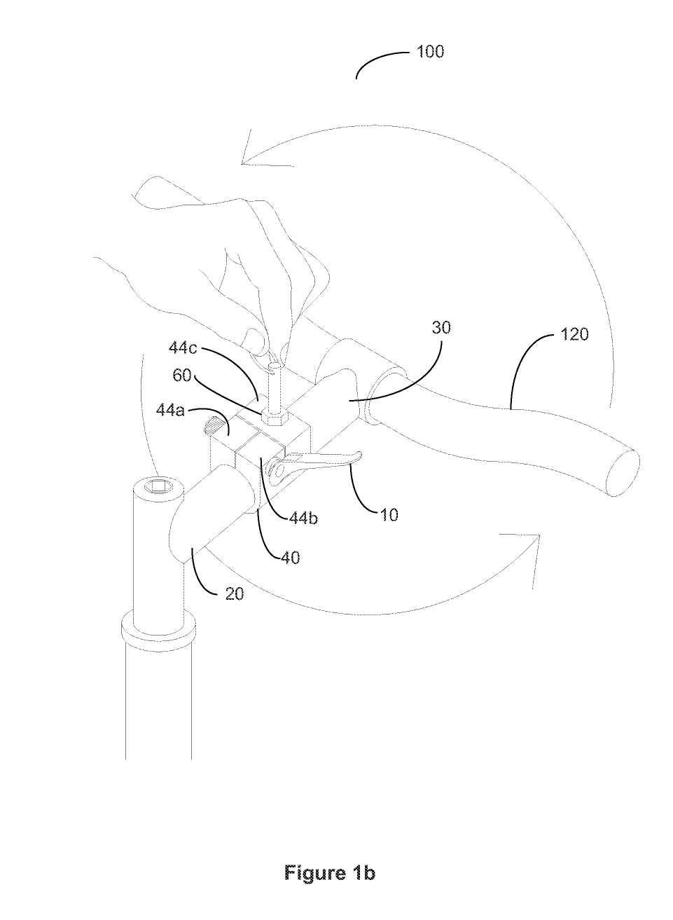

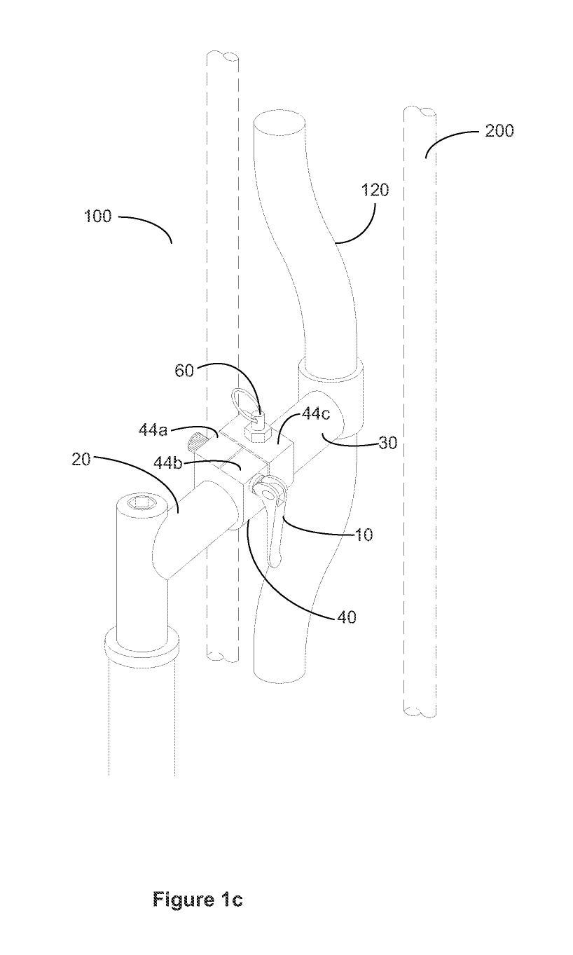

FIG. 1a illustrates a perspective view of an exemplary embodiment of pivotable handlebar stem apparatus 100 with handlebars 120 in the riding position. Pivotable handlebar stem apparatus 100 is comprised of clamp body 40, cam lock 10, and positioning component 60.

In the embodiment shown, clamp body 40 is secured around handlebar stem inner sleeve 20 and handlebar stem outer sleeve 30 of a bicycle and is comprised of clamp body sections 44a, 44b, 44c separated by slots 42a, 42b. In the embodiment shown, slot 42a separates clamp body sections 44a from clamp body section 44b and slot 42b separates clamp body sections 44a, 44b from clamp body section 44c.

When cam lock 10 is locked, clamp body sections 44a, 44b are pinched together creating the clamping force necessary to secure clamp body 40 tightly around handlebar stem inner and outer sleeves 20, 30 and preventing handlebars 120 from being rotated from a riding position to a parked position and vice versa. When cam lock 10 is unlocked, clamp body sections 44a, 44b are loosened around handlebar stem inner and outer sleeves 20, 30 allowing handlebars 120 to be rotated when positioning component 60 is disengaged.

In the embodiment shown, cam lock 10 is in the locked position. When cam lock 10 is in the locked position, handlebars 120 are secured either in riding position or in parked position.

Positioning component 60 retains inner sleeve 20 to outer sleeve 30 and allows for positional rotation of handlebars 120 from a riding position (FIG. 1a) to a parked position (FIG. 1c).

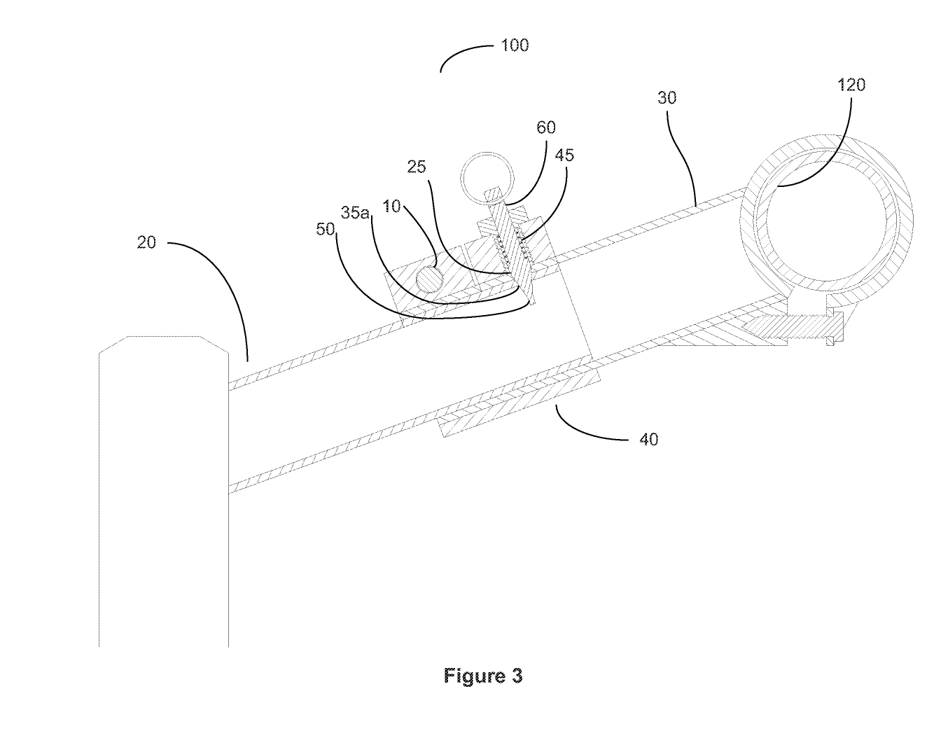

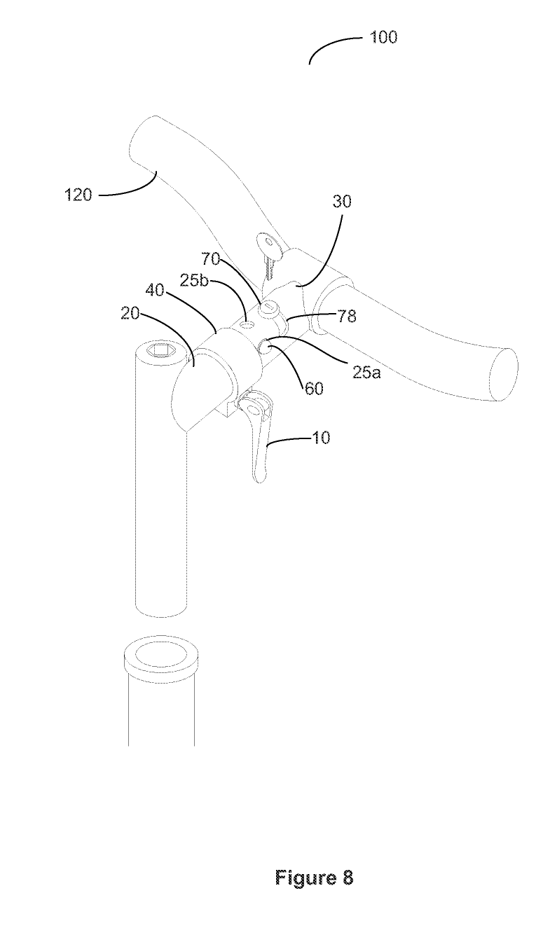

In the embodiment shown, positioning component 60 is a retractable plunger. In other embodiments, positioning component 60 may be a straight-line action clamp (FIG. 3), a push button (FIG. 8), a detent pin, a lever assembly, or any other component or assembly capable of securely retaining inner sleeve 20 to outer sleeve 30.

In the embodiment show, clamp body 40 is comprised of aluminum; however, in other embodiments, clamp body 40 may be comprised of steel, another type of metal or other material known in the art which is capable of being secured around a handlebar stem.

In the embodiment shown, clamp body 40 is formed as a single component which is installed around the handlebar stem inner sleeve 20 and handlebar stem outer sleeve 30 during manufacturing and is added to the bicycle during assembly. In other embodiments, handlebar stem 130 and handlebars 120 with pivotable handlebar stem apparatus 100 may be sold as aftermarket components and installed on a bicycle by removing the existing handlebar stem 130 and handlebars 120 from head tube 140.

Also visible in the embodiment shown is a portion of bicycle rack 200. Pivotable handlebar stem apparatus 100 may be used to secure a bicycle to a bicycle rack. To secure a bicycle with pivotable handle stem apparatus 100 to a bicycle rack, handlebars 120 are rotated from a riding position to a parked position and then inserted between the vertical rails of bicycle rack 200 (see FIG. 1c). Handlebars 120 are then rotated back to the riding position, securing the bicycle to the bicycle rack.

FIG. 1b illustrates a perspective view of an exemplary embodiment of pivotable handlebar stem apparatus 100 with cam lock 10 unlocked, positioning component 60 disengaged, and handlebars 120 in the riding position. To unlock pivotable handlebar stem apparatus 100, cam lock 10 is unlocked and positioning component 60 is disengaged from clamp body 40. When cam lock 10 is unlocked and positioning component 60 has been disengaged from clamp body 40, handlebars 120 may be rotated to a parked position. When handlebars 120 are rotated, handlebar stem outer sleeve 30 also rotates.

In the embodiment shown, handlebars 120 are designed to be rotated counterclockwise.

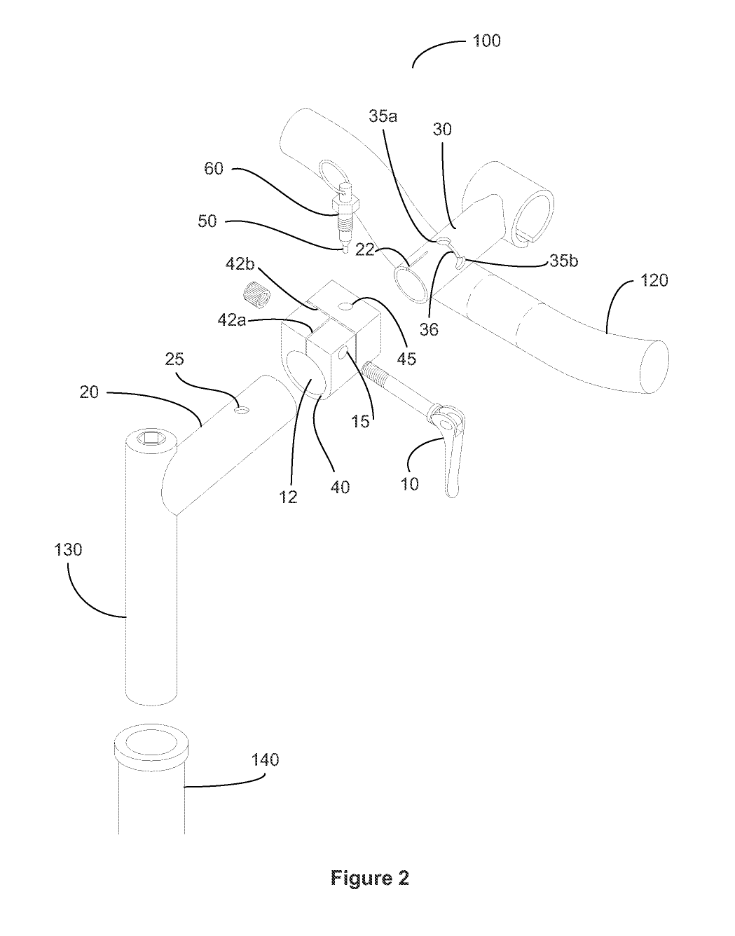

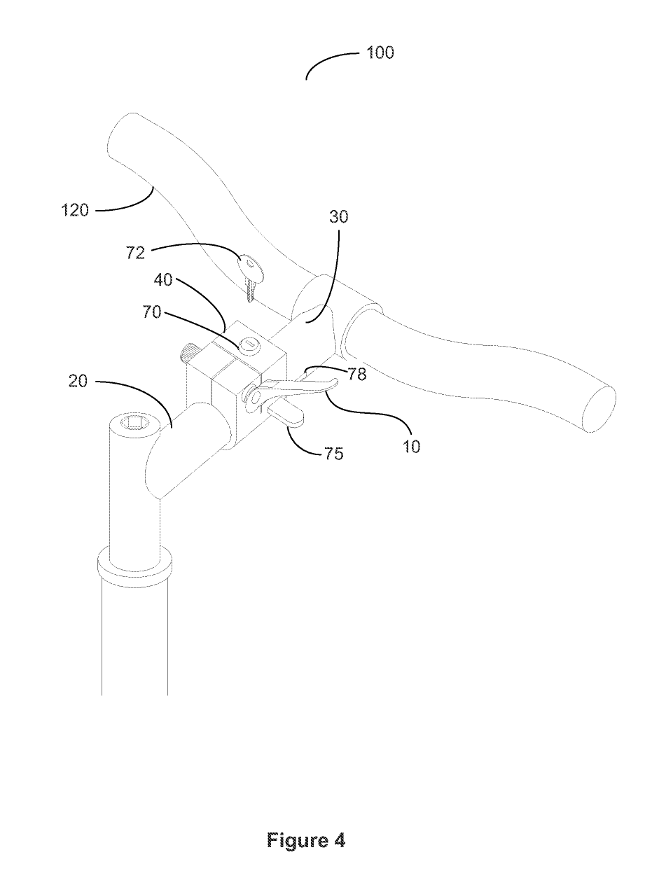

In the embodiment shown, positioning component 60 has threads that correspond to threads in aperture 45 in clamp body and positioning component 60 is rotated to disengage from clamp body 40 (see FIGS. 2 and 3). In various other embodiments, positioning component 60 may be disengaged using another means. For example, raising the lever portion of a straight-line action clamp (see FIG. 4) or pressing a push button (see FIG. 8).

FIG. 1c illustrates a perspective view of an exemplary embodiment of pivotable handlebar stem apparatus 100 with cam lock 10 locked, positioning component 60 engaged, and handlebars 120 in the parked position. In the embodiment shown, handlebars 120 have been rotated to a parked position. In the embodiment shown, handlebars 120 are rotated counterclockwise to a parked position; however, in other embodiments, handlebars 120 may be rotated clockwise to a parked position.

To secure handlebars 120 in a parked position, positioning component 60 is released back into clamp body 40 and cam lock 10 is locked. To return handlebars 120 to a riding position, cam lock 10 is unlocked and positioning component 60 is disengaged from clamp body 40. Handlebars 120 may be then be rotated clockwise to the riding position, positioning component 60 released back into clamp body 40, and cam lock 10 locked.

In the embodiment shown, handlebars 120 are being inserted through the vertical rails of bicycle rack 200.

FIG. 2 illustrates an exploded view of an exemplary embodiment of pivotable handlebar stem apparatus 100. Visible in clamp body 40 are aperture 12 for handlebar stem outer sleeve 30 and handlebar stem inner sleeve 20, aperture 15 for inserting cam lock 10, and aperture 45 for inserting positioning component 60.

When pivotable handlebar stem apparatus 100 is assembled, positioning component 60 passes through aperture 45 in clamp body 40, through aperture 35a in handlebar stem outer sleeve 30 and into aperture 25 in handlebar stem inner sleeve 30. When positioning component 60 is disengaged, retaining pin 50 of positioning component 60 is capable of moving along slot 36 allowing handlebars to be rotated counterclockwise to a parked position. Retraining pin 50 will be at rest in aperture 25 in handlebar stem inner sleeve 20. Handlebar 120 will be in riding position when retaining pin 50 engages apertures 25 and 35a, and will be in parked position when retaining pin 50 engages apertures 35b and 25. The body of positioning component 60 is too wide to move through slot 36 so handlebars 120 are secured in the parked position until positioning component 60 is disengaged.

In the embodiment shown, handlebars 120 may be secured in only two positions: a riding position (positioning component 60 inserted into aperture 35a) and a parked position (positioning component 60 inserted into aperture 35b). In addition, the design shown ensures that handlebars 120 are correctly and safely positioned.

Also visible in the embodiment shown is slot 22 on handlebar stem outer sleeve 30. Slot 22 allows handlebar stem outer sleeve 30 to fit more tightly around handlebar stem inner sleeve 20.

In the embodiment shown, there is a small overlap between handlebar stem outer sleeve 30 and handlebar stem inner sleeve 20 when pivotable handlebar stem apparatus 100 is assembled (see FIG. 3). In other embodiments, aperture 25 may be moved closer to handlebar stem 130 and apertures 35a, 35b and slot 36 may be moved closer to handlebars 120 resulting in a greater overlap between handlebar stem outer sleeve 30 and handlebar stem inner sleeve 20 when pivotable handlebar stem apparatus 100 is assembled and providing additional strength.

FIG. 3 illustrates a sectional view of an exemplary embodiment of pivotable handlebar stem apparatus 100 and handlebar stem outer sleeve 30, handlebar stem inner sleeve 20, and handlebars 120. Visible in the embodiment shown are threaded regions of positioning component 60 and aperture 45 of clamp body 40.

In the embodiment shown, positioning component 60 is in the locked position and passes through aperture 35a in handlebar stem outer sleeve 30 (handlebars 120 in riding position), engaging aperture 25 in handlebar stem inner sleeve 20.

FIG. 4 illustrates a perspective view of a second exemplary embodiment of pivotable handlebar stem apparatus 100 with an anti-theft lock assembly comprised of locking cylinder 70, key 72, locking arm 75 and locking arm slot 78. In the embodiment shown, anti-theft lock assembly is locked, preventing handlebars 120 from being rotated. To unlock the anti-theft lock assembly, key 72 is inserted into locking cylinder 70 and rotated causing locking arm 75 to slide out of clamp body 40 and into locking arm slot 78. Handlebars 120 may then be rotated to a parked position.

Including an anti-theft lock assembly with pivotable handlebar stem apparatus 100 may serve as a theft deterrent. For example, key 72 will be necessary to rotate handlebars 120 from a parked position to a riding position; when handlebars 120 are in a parked position, the bicycle cannot be ridden, which may deter a potential thief. In addition, if the bicycle is secured to a bicycle rack as shown in FIG. 1a, handlebars 120 cannot be rotated to remove the bicycle from the bicycle rack without key 72, preventing the bicycle from being stolen without the removal of one or more components of the bicycle.

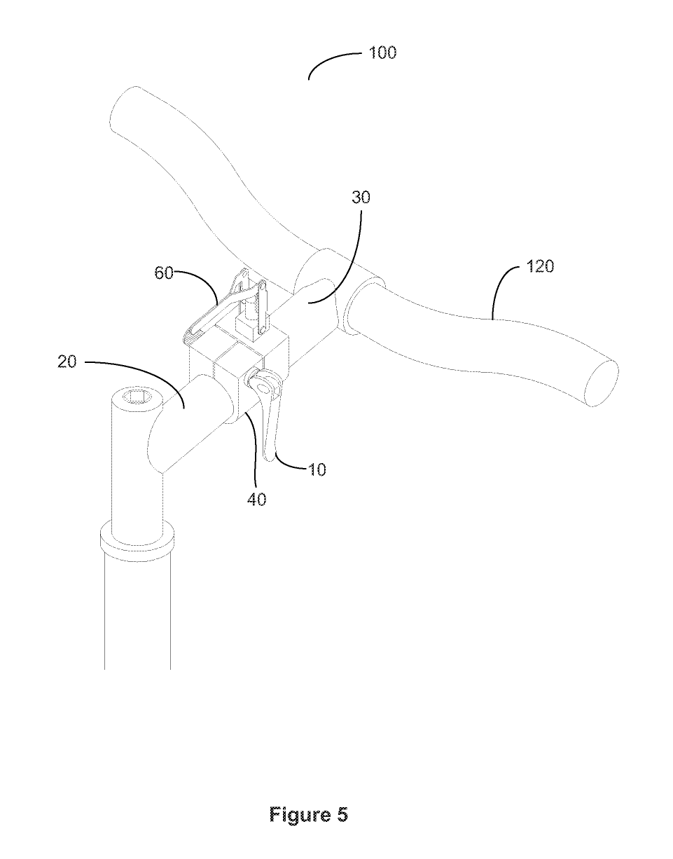

FIG. 5 illustrates a perspective view of an exemplary alternative embodiment of pivotable handlebar stem apparatus 100 with cam lock 10 locked and handlebars 120 in the riding position. In the embodiment shown, positioning component 60 is a straight-line action clamp, which is disengaged from clamp body 40 by raising the lever portion of the straight-line action clamp.

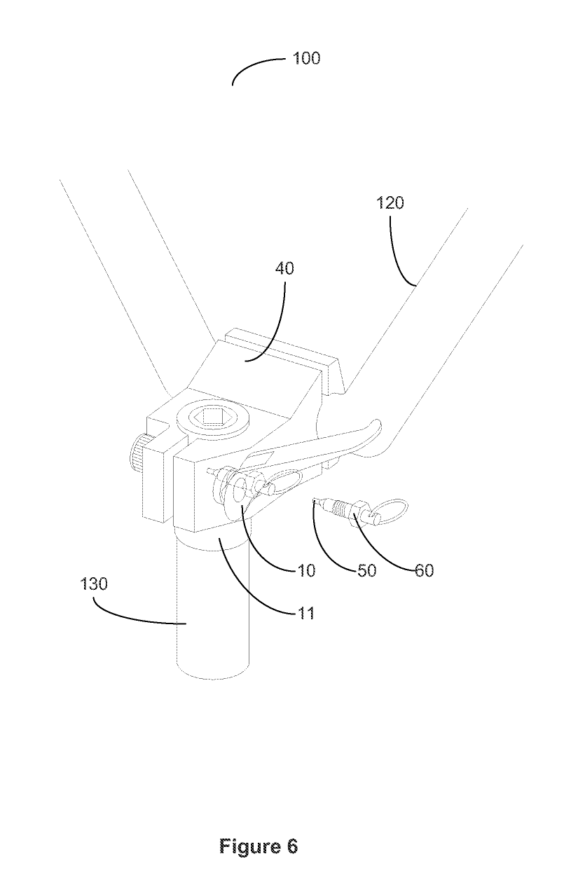

FIG. 6 illustrates a perspective view of a second exemplary embodiment of pivotable handlebar stem apparatus 100 with cam lock 10 locked, positioning component 60 disengaged, and handlebars 120 in the riding position. In the embodiment shown, clamp body 40 is comprised of two pieces and is for use with bicycles with v-shaped handlebars, typically youth bikes, as opposed to bicycles with straight handlebars as shown in FIGS. 1 through 5. Clamp body 40 is secured around handlebar stem 130 and clamps the flattened portion at the bottom of handlebars 120.

In the embodiment shown, pivotable handlebar stem apparatus 100 includes cam lock 10, positioning component 60, which is inserted through clamp body 40 adjacent to cam lock 10 (see FIG. 5b), and collar 11, which prevents clamp body 40 from sliding down handlebar stem 130. In the embodiment shown, positioning component 60 is a retractable plunger.

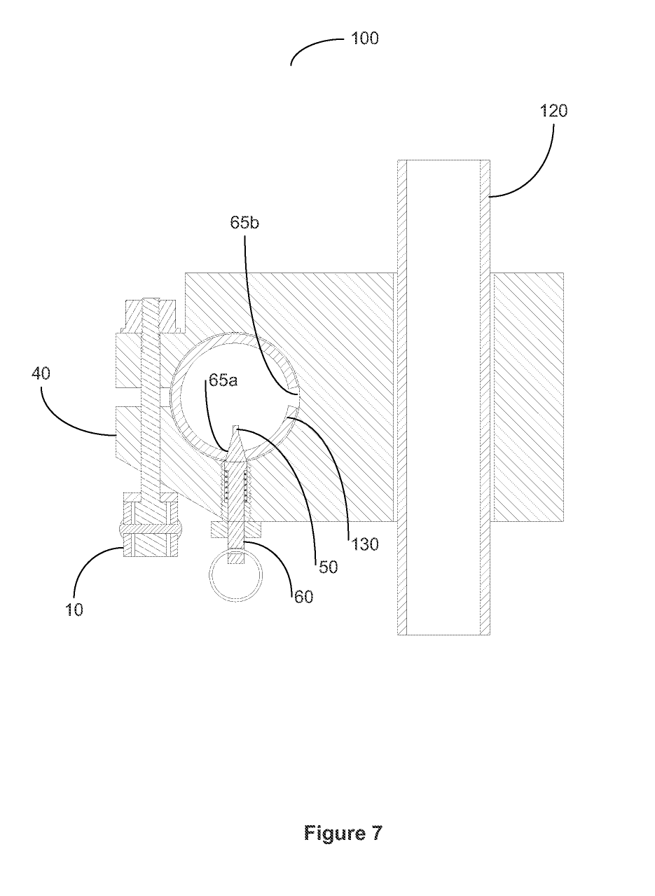

FIG. 7 illustrates a sectional view of a second exemplary embodiment of pivotable handlebar stem apparatus 100 with positioning component 60 engaged and handlebars 120 in the riding position.

When handlebars 120 are in the riding position, positioning component 60 is engaged and is inserted through aperture 65a in handlebar stem 130. When cam lock 10 is unlocked and positioning component 60 is disengaged, clamp body 40 and handlebars 120 may be rotated clockwise until aperture 65b is lined up with positioning component 60. Positioning component 60 may be then be engaged by inserting it through aperture 65b into handlebar stem 130. Cam lock 10 is then locked, securing handlebars 120 in the parked position.

In various other embodiments, pivotable handlebar stem apparatus 100 may further include an anti-theft lock assembly.

FIG. 8 illustrates a perspective view of a third exemplary embodiment of pivotable handlebar stem apparatus 100 with an anti-theft lock assembly. In the embodiment shown, clamp body 40 is comprised of a collar that encircles handlebar stem outer sleeve 20 and handlebar stem inner sleeve 30. In the embodiment shown, positioning component 60 is a push button, which is disengaged by pressing. In the embodiment shown, the anti-theft lock assembly is comprised of locking cylinder 70 and slot 78.

In the embodiment shown, cam lock 10 is locked, positioning component 60 is engaged, and handlebars 120 are in the riding position. To rotate handlebars 120 to a parked position, cam lock 10 is unlocked and positioning component 60 is pressed, allowing handlebars 120 to be rotated counterclockwise to a parked position. When handlebars 120 are in the riding position, positioning component 60 protrudes through aperture 25a in handlebar stem outer sleeve 30. When handlebars 120 are in the parked position, positioning component 60 protrudes through aperture 25b in the handlebar stem outer sleeve 30.

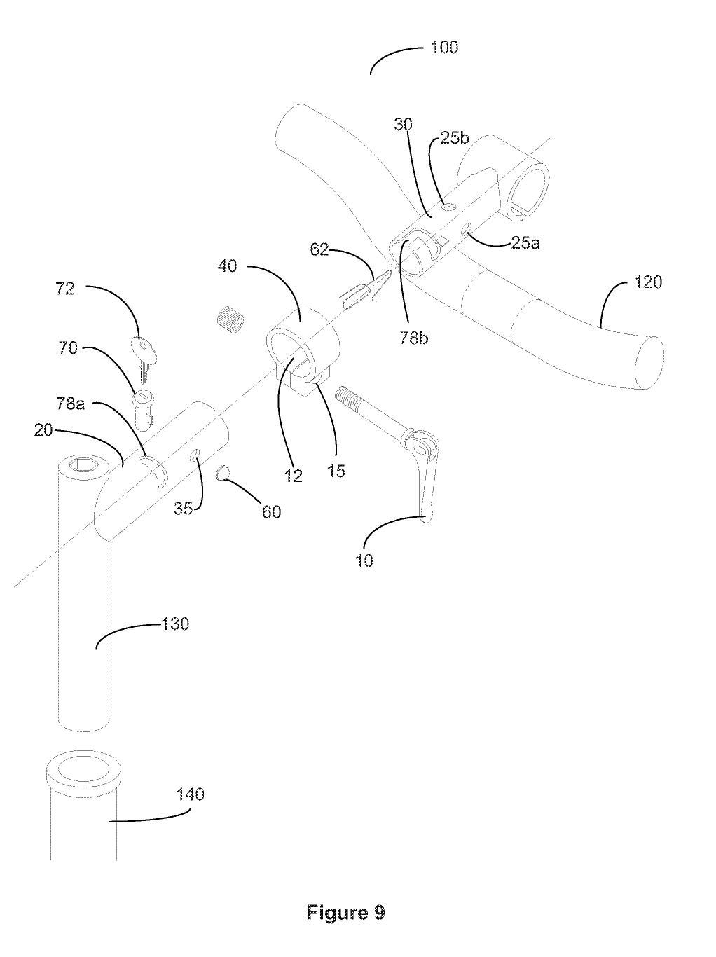

FIG. 9 illustrates an exploded view of a third exemplary embodiment of pivotable handlebar stem apparatus 100 with an anti-theft lock assembly. Visible in clamp body 40 are aperture 12 for handlebar stem outer sleeve 30 and handlebar stem inner sleeve 20 and aperture 15 for inserting cam lock 10.

Handlebar stem outer sleeve 30 has apertures 25a, 25b for positioning component 60 and slot 78a for locking cylinder 70. Handlebar stem inner sleeve 20 has aperture 35 for positioning component 60 and slot 78b for locking cylinder 70. Also visible is spring 62, which allows positioning component 60 to disengage and reengage.

When handlebars 120 are in the riding position, positioning component 60 resides in aperture 35 in handlebar stem inner sleeve 20 and protrudes through aperture 25a in handlebar stem outer sleeve 30. When cam lock 10 is unlocked and positioning component 60 is pressed, handlebar stem outer sleeve 30 and handlebars 120 may be rotated counterclockwise. When handlebar stem outer sleeve 30 and handlebars 120 are rotated, positioning component 60 rests in handlebar stem inner sleeve 20 and re-engages outer sleeve 30 and aperture 25b. Handlebars 120 are rotated until positioning component 60 protrudes through aperture 25b in handlebar stem outer sleeve 30.

When handlebars 120 are in the parked position, positioning component 60 may be pressed to allow the handlebars to be rotated clockwise back to the riding position.

What is claimed is:

1. A pivotable handlebar stem apparatus comprised of:
a clamp body which fits around outer and inner sleeves of a handlebar stem;
a cam lock, said cam lock passes completely through said clamp body creating a clamping force; and
a positioning component, said positioning component passes through said clamp body and through said outer sleeve into said inner sleeve;
wherein when said cam lock is locked and said positioning component is engaged, handlebars are secured in one of two positions.

2. The apparatus of claim 1 wherein when said cam lock is unlocked and said positioning component is disengaged, said handlebars may be rotated between a riding position and a parked position.

3. The apparatus of claim 1 wherein said positioning component is selected from the group consisting of a retractable plunger, a push button, a straight-line action clamp, a detent pin, a lever assembly and combinations thereof.

4. The apparatus of claim 1 which further includes at least one rigid locking component.

5. The apparatus of claim 1 wherein said outer sleeve rotates outside said inner sleeve when said handlebars are rotated.

6. The apparatus of claim 1 wherein said handlebars are rotated counterclockwise.

7. The apparatus of claim 1 which further includes an anti-theft lock assembly.

8. A pivotable handlebar stem apparatus comprised of:
a clamp body which fits around outer and inner sleeves of a handlebar stem;
a cam lock, said cam lock passes completely through said clamp body creating a clamping force;
a positioning component, said positioning component passes through said clamp body and through said outer sleeve into said inner sleeve;
wherein when said cam lock is locked and said positioning component is engaged, handlebars are secured in one of two positions; and
an anti-theft lock component.

9. The apparatus of claim 8 wherein said anti-theft lock component is selected from the group consisting of a locking cylinder, a key, a locking arm, a slot and combinations thereof.

10. The apparatus of claim 8 wherein when said cam lock is unlocked and said positioning component is disengaged, said handlebars may be rotated between a riding position and a parked position.

11. The apparatus of claim 8 wherein said positioning component is selected from the group consisting of a retractable plunger, a push button, a straight-line action clamp, a detent pin, a lever assembly and combinations thereof.

12. The apparatus of claim 8 which further includes at least one rigid locking component.

13. The apparatus of claim 8 wherein said outer sleeve rotates outside said inner sleeve when said handlebars are rotated.

14. The apparatus of claim 8 wherein said handlebars are rotated counterclockwise.

15. A pivotable handlebar assembly apparatus comprised of:
a clamp body which fits around outer and inner sleeves of a handlebar stem;
a cam lock, said cam lock passes completely through said clamp body creating a clamping force;
a positioning component, said positioning component passes through said clamp body and through said outer sleeve into said inner sleeve;
wherein when said cam lock is locked and said positioning component is engaged, handlebars are secured in one of two positions;
a set of handlebars; and
a handlebar stem, which may be inserted into the head tube of a bicycle.

16. The apparatus of claim 15 wherein when said cam lock is unlocked and said positioning component is disengaged, said handlebars may be rotated between a riding position and a parked position.

17. The apparatus of claim 15 wherein said positioning component is selected from the group consisting of a retractable plunger, a push button, a straight-line action clamp, a detent pin, a lever assembly and combinations thereof.

18. The apparatus of claim 15 wherein said outer sleeve rotates outside said inner sleeve when said handlebars are rotated.

19. The apparatus of claim 15 wherein said handlebars are rotated counterclockwise.

20. The apparatus of claim 15 which further includes an anti-theft lock assembly.
